(19) United States
(12) Patent Application Publication
(10) Pub. No.: US 2018/0181544 A1
(43) Pub. Date: Jun. 28, 2018

(54) Systems for Automatically Extracting Job Skills from an Electronic Document

(71) Applicant: Google Inc., Mountain View, CA (US)

(72) Inventors: Zhao Zhang, Santa Clara, CA (US); Chao Chen, Sunnyvale, CA (US); Christian Posse, Belmont, CA (US); Xuejun Tao, San Jose, CA (US); Pei-Chun Chen, Mountain View, CA (US); Julie Park, Mountain View, CA (US)

(21) Appl. No.: 15/391,946

(22) Filed: Dec. 28, 2016

(51) Int. Cl. G06F 17/21; G06Q 10/10; G06N 99/00; G06N 7/00; G06F 17/27

(52) U.S. Cl. CPC G06F 17/211; G06Q 10/1053; G06F 17/2735; G06N 7/005; G06F 17/2705; G06N 99/005

(57) ABSTRACT

Systems and methods for extracting job skills from a job posting are provided. In one embodiment, a computer-implemented method includes obtaining data indicative of a job posting (including textual content associated with a job). The method includes identifying a portion of the textual content that is descriptive of one or more skills associated with the job. The portion of the textual content is in a first format. The method includes converting the portion of the textual content that is descriptive of the one or more skills associated with the job from the first format to a second format. The second format includes one or more text strings. The method includes determining the one or more skills associated with the job based at least in part on one or more of the text strings. The method includes providing an output indicative of the one or more skills associated with the job posting.

### FIELD

The present disclosure relates generally to automatically extracting information from an electronic document.

### BACKGROUND

A skills requirement section is often the gist of a job posting. However, identification of a skills requirement section it is not an easy task for computers, for several reasons. First, the section that contains skill requirements may appear in a variety of positions within a job posting. Second, when writing job descriptions, people sometimes mistakenly place skill requirements in other sections of a job posting. Third, a job description could be formatted in various ways, making it difficult for a computer to apply pattern recognition techniques. Lastly, there is often no consensus about what items constitute a skill.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of extracting job skills from a job posting. The method includes obtaining, by one or more computing devices, data indicative of a job posting, wherein the job posting comprises textual content associated with a job. The method includes identifying, by the one or more computing devices, a portion of the textual content that is descriptive of one or more skills associated with the job. The portion of the textual content is in a first format. The method includes converting, by the one or more computing devices, the portion of the textual content that is descriptive of the one or more skills associated with the job from the first format to a second format. The second format includes one or more text strings. The method includes determining, by the one or more computing devices, the one or more skills associated with the job based at least in part on one or more of the text strings. The method includes providing, by the one or more computing devices, an output indicative of the one or more skills associated with the job posting.

Other example aspects of the present disclosure are directed to systems, apparatuses, tangible, non-transitory computer-readable media, user interfaces, memory devices, and electronic devices for extracting skills from a job posting.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for extracting job skills according to example embodiments of the present disclosure;

FIG. 2 depicts a flow diagram of an example method of extracting job skills according to example embodiments of the present disclosure;

FIG. 3 depicts a flow diagram of an example method of determining skills associated with a job according to example embodiments of the present disclosure; and

FIG. 4 depicts an example computing device with components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to automatically identifying and extracting job skills identified in a job posting. For instance, a computing system can receive a job posting seeking candidates for a job (e.g., a software engineer). The computing system can obtain the job posting from an entity (e.g., an employer, staffing agency, recruiter) and/or via web-crawling techniques (e.g., crawling social media, professional job listing webpages). The job posting can include textual content that is descriptive of one or more characteristic(s) of a job (e.g., title, location, salary, job description). The computing system can identify a skill dense section of the job posting by, for example, inputting the textual content of the job posting into a machine-learned classifier model. The computing system can extract one or more skill(s) (e.g., experience with C++) associated with the job (e.g., a software engineer) from the skills dense section, as will be further described herein. In this way, the computing system can provide an output indicative of the skill(s) for display via a user interface, for suggesting skills that may be missing from the job posting, etc.

The systems and methods of the present disclosure provide a number of technical effects and benefits. For instance, systems and methods enable a computing system to address the problem of computer-implemented identification and extraction of skills from a job posting. More particularly, the systems and methods allow a computing system to identify skills with high precision and recall, which is helpful when a large number of job postings need to be processed in a short amount of time. Furthermore, employers, job aggregators, and/or job seekers can leverage the systems and methods of the present disclosure to extract critical skill information, surface more relevant jobs according to user queries, as well as to identify skills missing from a job posting. This can lead to more efficient recruitment by matching good candidates with ideal jobs that align with their skill sets. Additionally, the systems (e.g., including its algorithms, models) of the present disclosure can be configured such that more rich features can easily be developed on top of the systems.

The systems and methods of the present disclosure also provide an improvement to computing technology. For instance, the methods and systems enable a computing system to efficiently and effectively extract job skills from a job posting. The computing system can obtain data indicative of a job posting (e.g., including textual content associated with a job). The computing system can identify a portion of the textual content that is descriptive of one or more skill(s) associated with the job using the processes described herein. Restricting the scope of the analysis to a subset of an entire job posting saves computational resources (e.g., processing resources) as well as improves the precision of the eventual extraction. The computing system can convert the portion of the textual content that is descriptive of the one or more skill(s) associated with the job from a first format to a second format (e.g., including text string(s)). This can allow the system to structure the skills portion of the job posting in a format that makes it easier for the computing system to identify skills, thereby decreasing the necessary processing time. The computing system can determine the one or more skill(s) associated with the job based at least in part on one or more of the text strings (of the identified portion). Moreover, the computing system can provide an output indicative of the one or more skill(s) associated with the job posting (e.g., for display, for a third party). This can enable a computing device associated with a third party and/or a user to leverage the computational resources of the computing system to extract job skills, thus allowing the computing device (e.g., of the third party, of the user) to allocate its resources to more core functions (e.g., faster job aggregation, faster user interface generation).

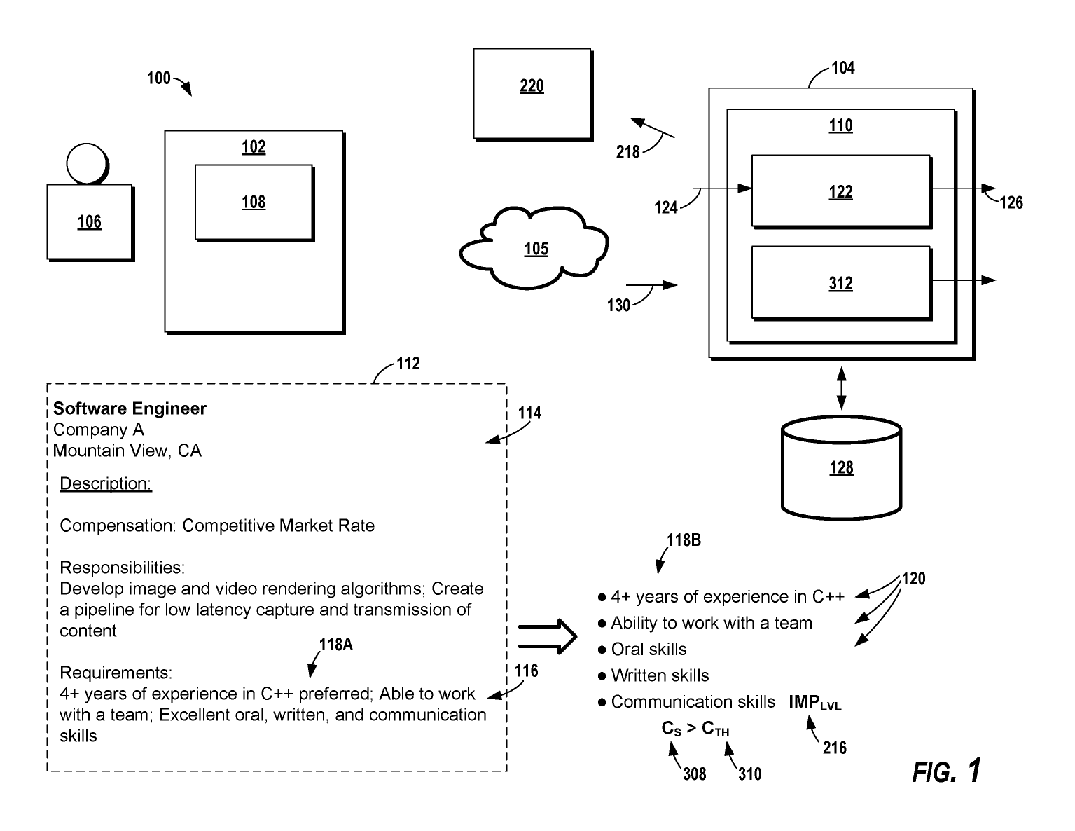

With reference now to the FIGS., example embodiments of the present disclosure will be discussed in further detail. FIG. 1 depicts an example system 100 for extracting job skills according to example embodiments of the present disclosure. The system 100 can include a user computing device 102 and a computing system 104. The user computing device 102 and a computing system 104 can be configured to communicate with one another via one or more wired and/or wireless network(s) 105. While the following description describes the operations and functions for extracting job skills as being performed by the computing system 104, one or more of the operations and functions for extracting job skills can also, or alternatively, be performed by the user computing device 102.

The user computing device 102 can be utilized by a user 106. The user computing device 102 can include, for example, a phone, a smart phone, a computerized watch (e.g., a smart watch), computerized eyewear, computerized headwear, other types of wearable computing devices, a tablet, a personal digital assistant (PDA), a laptop computer, a desktop computer, a gaming system, a media player, an e-book reader, a television platform, a navigation system, a digital camera, an appliance, and/or any other type of mobile and/or non-mobile user computing device. The user computing device 102 can include computing component(s) (e.g., including processors, memory devices, etc.) for performing various operations and functions, as described herein. Moreover, the user computing device 102 can also include one or more display device(s) 108 (e.g., display screen, CRT, LCD, plasma screen, touch screen, TV, projector) configured to display a user interface.

The computing system 104 can be, in some implementations, a web-based server system. The computing system 104 can include components for performing various operations and functions as described herein. For instance, the computing system 104 can include one or more computing device(s) 110 (e.g., servers). The computing device(s) 110 can include one or more processor(s) and one or more memory device(s). The one or more memory device(s) can store instructions that when executed by the one or more processor(s) cause the one or more processor(s) to perform operations and functions, such as those for extracting skill(s) from a job posting 112 (e.g., methods 200, 300).

A job posting 112 can be included in an electronic document. The job posting 112 can include textual content 114 associated with a job (e.g., software engineer for Company A). For example, the textual content 114 can include a job title, a location, a company, compensation, work environment, company overview, responsibilities, qualifications, requirements, etc. In some implementations, such content can be organized within the job posting 112 as separate sections. In some implementations, the various types of textual content 114 can appear together. The job posting 112 can include one or more skill section(s). For example, the job posting can include one or more portion(s) 116 of the textual content 114 that are descriptive of one or more skill(s) associated with the job. At least a subset of the portion(s) 116 can be in a first format 118A (e.g., sentences, separated by punctuation). As further described herein, the computing 110 can convert the portion 116 to a second format 118B. The second format can include one or more string(s) 120 (e.g., text strings, vector strings).

The computing device(s) 110 can include various models for processing the job posting 112. For example, the computing device(s) 110 can include an identification model 122 (e.g., a classifier model) configured to identify a section of the job posting 116, such as a skills dense section (e.g., portion 116). The model 122 can be or can otherwise include various machine-learned models such as neural networks (e.g., deep neural networks) or other multi-layer non-linear models. Neural networks can include recurrent neural networks (e.g., long short-term memory recurrent neural networks), feed-forward neural networks, or other forms of neural networks. The model 122 can receive an input 124 including, at least, data indicative of the job posting 112. The model 122 can be trained to provide a model output 126 that is indicative of the portion 116 of the textual content 114 that is descriptive of one or more skill(s) associated with the job based at least in part on the input 124.

The model 122 can be trained using various training or learning techniques, such as, for example, backwards propagation of errors. In some implementations, performing backwards propagation of errors can include performing truncated backpropagation through time. A model trainer (e.g., of the computing system 104, of another computing system) can perform a number of generalization techniques (e.g., weight decays, dropouts, etc.) to improve the generalization capability of the models being trained.

The model 122 can be trained using suitable training data. For instance, the training data can include labeled job posting training data with labeled sections (e.g., requirements, responsibilities, company overview, compensation, work environment, other sections). The model 122 can be trained to assign a section category to a string with a probability. The model 122 can be based at least in part on bag of words and can use features such as n-grams and skip-grams. Transition rules can also be encoded into the overall logic of the model 122. The transition rules can indicate the probability of observing a certain section category after observing one category. The model 122 can be tested using new job postings with known sections to determine the accuracy of the model 122.

The computing system can access a database 128 that includes data indicative of a vocabulary. The vocabulary can include a clean list of skills, which can be used to perform string based matching, as further described herein. The vocabulary can be built from various sources including to online professional networks, job boards, blogs, news articles, resumes, user profiles (e.g., on job searching sites), etc. The vocabulary can include skills that have been cleaned, for example, by a cleaner engine and/or a spell correction engine that takes a raw skill term/phrase (e.g., parsed from the sources) as an input and outputs a clean skill term/phrase and/or an empty string. The cleaning can include removing unwanted symbols (e.g., punctuation), removing unwanted numbers, removing stop words, removing skill specific stop words, stemming, synonym/acronym conversion, and/or other procedures. The vocabulary can be used to help identify the skills of the job posting 112.

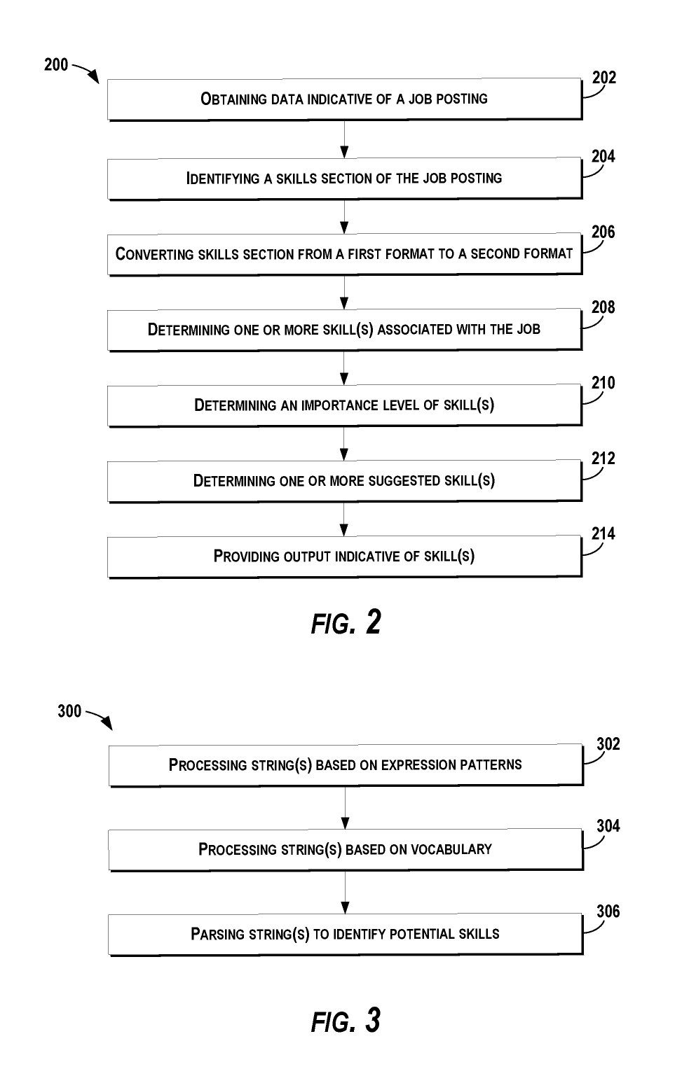

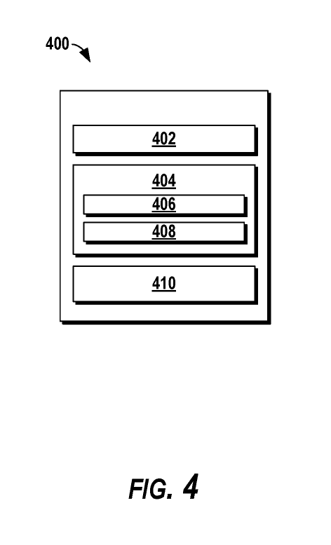

FIG. 2 depicts a flow chart of an example method 200 of extracting job skills from a job posting according to example embodiments of the present disclosure. One or more portion(s) of method 200 can be implemented by a user computing device (e.g., 102) and/or other computing device(s) (e.g., 110), such as, for example, those shown in FIGS. 1 and 4. One or more portion(s) of method 200 can be implemented as an algorithm on the hardware (e.g., computer components of FIG. 4) to perform the computer-implemented function(s) as set forth in the claims. FIG. 2 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), the method 200 can include obtaining data indicative of a job posting. For instance, the computing device(s) 110 can include obtaining data 130 indicative of a job posting 112 (e.g., as shown in FIG. 1). The data 130 indicative of the job posting 112 can be provided via a computing device of a third party (e.g., employer, staffing agency, recruiter) via an application programming interface (API). In some implementations, the computing device(s) 110 can be configured to crawl information (e.g., employer job listing pages, job sites, recruiting sites, social media, web pages) to obtain the data 130 indicative of the job posting 112. In some implementations, the data 130 can be data (e.g., image data) indicative of a hardcopy of a job posting 112 (e.g., captured via an imaging platform). As described herein, the job posting 112 can include textual content 114 associated with a job (e.g., Software Engineer for Company A).

At (204), the method 200 can include identifying a skills section of the job posting. For instance, the computing device(s) 110 can identify a portion 116 of the textual content 114 that is descriptive of one or more skill(s) associated with the job. The portion 116 of the textual content 114 can be in a first format 118A. By way of example, the portion 116 can include phrases such as “4+ years of experience in C++ preferred,” “Able to work with a team,” etc. separated by punctuation. To identify the portion 116 (e.g., a skills dense section), the computing device(s) 110 can input data indicative of the textual content 114 associated with the job into the machine-learned model 122. As described herein, the model 122 can be trained to identify one or more portion(s) 116 (e.g., of the job posting 112) that are descriptive of skills associated with the job. The computing device(s) 110 can obtain a model output 126 that is indicative of the portion 116 of the textual content 114 that is descriptive of one or more skill(s) associated with the job.

At (206), the method 200 can include converting the skills section of the job posting from a first format to a second format. For instance, the computing device(s) 110 can standardize the portion 116 descriptive of the one or more skill(s) associated with the job. The computing device(s) 110 can convert the portion 116 of the textual content 114 that is descriptive of one or more skill(s) associated with the job from the first format 118A to a second format 118B. The second format 118B can include one or more string(s) 120 (e.g., text string(s)). For instance, the second format 118B can include a list of the one or more string(s) 120. Each string can be formatted as separate from the other string(s) 120. For instance, each string 120 can be formatted as a separate bullet point (e.g., as shown in FIG. 1). In this way, the computing device(s) 110 can format the portion 116 in a manner that provides a natural boundary between skills and, thus, are more manageable computing units. For instance, a robust algorithm that works well on one string (e.g., in a bullet point) can be repeatedly applied to all strings (e.g., in other bullet points) in the portion 116 (e.g., a skills dense section). Such an algorithm is significantly easier to design. Moreover, this can allow the computing device(s) 110 to process one string 120 (e.g., in a single bullet point) at a time until all strings are processed. The computing device(s) can aggregate the results of each string 120 (e.g., associated with each bullet point). In some implementations, the portion 116 may already be in a first format 118A that is formatted in a natural bullet point format. In such cases, the portion 116 can be formatted to a list of indicators (e.g., bullet point, string indicators) such as certain html tags and/or special characters. In some implementations, the potion 116 can be in a first format 118A such as a paragraph with no clear indicators (e.g., no indicators for bullet points). In such cases, the computing device(s) 110 can process each sentence as a separate string.

At (208), the method 200 can include determining one or more skill(s) associated with the job. For instance, the computing device(s) 110 can determine the one or more skill(s) associated with the job based, at least in part, on one or more of the text string(s) 120. As described herein, the computing device(s) 110 can treat a string 120 (e.g., in a bullet point) as a basic unit for extracting skill(s) from the job posting 112. The computing device(s) 110 can tokenize the string(s) 120 (and any punctuation) for ease of processing.

FIG. 3 depicts a flow diagram of an example method 300 of determining the one or more skill(s) according to example embodiments of the present disclosure. One or more portion(s) of method 300 can be performed within one or more portion(s) of method 200. For example, the computing device(s) 110 and/or the user computing device 102 can perform one or more of the portions (302) to (306) at (208) of method 200.

At (302), the computing device(s) 110 can process one or more of the string(s) 120 (e.g., text strings) to identify the one or more skill(s) based at least in part on one or more expression pattern(s). An expression pattern can be a pattern that a regular expression engine (e.g., of the computing device(s) 110) attempts to match in input text. An expression pattern can include one or more character literal(s), operator(s), and/or construct(s). For instance, the computing device(s) 110 can attempt to match the characters, terms, and/or phrases within a string 120 to a list of customized skills using regular expression patterns. The expression patterns can be associated with past experience, age limit, legal information (e.g., criminal background), fast-pace environment skills, multi-tasking skills, work independently skills, teamwork skills, physical strength requirement, and/or other factors. By way of example, the expression pattern for team work skills can be: ‘(team\s?(work|environment))|(as (part of)?a team)|(in (a|the)+team situation)’.

For each string 120 (e.g., of each bullet point), the entire string is searched with one or more of the expression pattern(s). Any matched patterns will be added to a list that stores all the skills for the given string 120 (and/or bullet point). The reason to have a separate list of customized skills is they are common but people often use different phrases to express the same skill. With regular expression, more possible variations can be captured than just using plain string matching.

At (304), the computing device(s) 110 can process one or more of the string(s) 120 based, at least in part, on the vocabulary (e.g., of database 128). For instance, the computing device(s) 110 can access data indicative of a vocabulary (e.g., stored within database 128) that comprises a plurality of terms related to a plurality of job skills, as described herein. The computing device(s) 110 can compare one or more of the string(s) 120 (e.g., text strings) to the vocabulary. The computing device(s) 110 can determine one or more skill(s) based, at least in part, on the comparison of one or more of the strings 120 (e.g., text strings) to the vocabulary.

For example, the computing device(s) 110 can conduct a comprehensive search for any exact match between n-grams in the string(s) 120 and skill terms/phrases in the controlled vocabulary (e.g., of database 118). The candidate n-grams in the string(s) 120 (e.g., bullet points) can include n-grams (e.g., n from 1 to 5 inclusively), two-gram skip one gram, three-gram skip one gram, etc. These can be selected to avoid including skip-grams that introduce too much random noise. Additionally, or alternatively, whenever keyword skills or certifications are identified, all the tokens in the string(s) 120 (e.g., in a bullet point) are searched against the pre-generated lists of skills and certifications. Every skill term/phrase in the vocabulary can have an identifier. Accordingly, the computing device(s) 110 can assign such an identifier to each of the skill(s) extracted in this step of method 300. Each identifier can represent a skill entity, making it easier and more efficient for the computing system 104 to organize and track the skill(s) from each job.

In some implementations, at (306), the computing device(s) 110 can parse one or more of the string(s) 120 to identify one or more potential skill(s). This can be done, for example, to any of the string(s) 120 for which a skill has not been extracted through another process (e.g., at (302), at (304)). In some implementations, this can be performed on a string 120 in addition to, or alternatively, from the processes of (302), (304). The computing device(s) 110 can determine a confidence score 308 (e.g., shown in FIG. 1) associated with a potential skill. The confidence score 308 can be indicative of the likelihood that the potential skill is at least one of the skill(s) associated with the job. The computing device(s) 110 can identify the potential skill as at least one of the skill(s) associated with the job when the confidence score 308 exceeds a confidence score threshold 310 (e.g., the minimum confidence level necessary to consider a potential skill a skill associated with the job).

For example, the computing device(s) 110 can use a semantic parser together with a list of anchor terms to identify potential skills (e.g., skill snippets). The semantic parser can perform part of speech tagging and build a parsing tree which shows the hierarchy of the tokens in a string 120. An anchor term can indicate that there might be a skill somewhere nearby, and the parsing tree can indicate exactly where the skill is relative to one or more anchor term(s). Therefore, by using the parsing tree with a list of pre-defined anchor terms, the computing device(s) 110 can locate the potential skills (e.g., skill snippets).

The computing device(s) 110 can utilize various types of anchor term(s). For instance, the anchor term(s) can include at least one of a leading anchor, trailing anchor, and skill stopword. Leading anchor terms can include the terms/phrases that often appear in front of a skill, such as for example, “able to,” “proficient in,” etc. Trailing anchor terms can include the terms/phrases that often appear after a skill, such as for example, “is a must,” “preferred,” etc. Skill stopwords can include terms/phrases that are often used to modify skills, such as “excellent,” “experienced,” “fluent,” etc. While the anchor terms may not necessarily, in normal context, indicate a skill, they can do so in the context of a skills section (e.g., 116) of a job posting (e.g., 112).

For each potential skill (e.g., skill snippet), the computing device(s) 110 can assign a skill identifier (e.g., from the vocabulary) and a confidence score 308. This can be done using a model 312 (e.g., shown in FIG. 1). The model 312 can be a machine-learned model similar to that of model 122, as described herein. In some implementations, the computing device(s) 110 can utilize a logistic regression based classifier in addition to and/or as part of the model 312. The model 312 can be trained by data indicative of labeled skill snippets with the existing skill entities. The model 312 can receive an input including, at least, data indicative of the one or more potential skill(s). The model 312 can be trained to provide a model output that is indicative of a confidence score 308 indicating the likelihood that the potential skill is at least one of the skill(s) associated with the job based at least in part on the input. In the event that the confidence score 308 exceeds a threshold 310, the potential skill can be identified as a skill associated with the job. Moreover, the model 312 can assign an identifier to each potential skill (e.g., skill snippet) to further structure the skill data of a job posting (e.g., included in an electronic document), making it easy to reason the relationships between skills, within the vocabulary, etc.

Returning to FIG. 2, the computing device(s) 110 can perform one or more action(s) based, at least in part, on the determined skills for the job posting 112. For example, at (210), the computing device(s) 110 can determine an importance level 216 (e.g., shown in FIG. 1) for each of the one or more skill(s) associated with the job posting 112. The importance level 216 can indicate the importance of the respective job skill to the job (e.g., of the job posting 112). To do so, for example, the computing device(s) 110 can compare the type of job (e.g., indicated in the job title) to the respective skill. In some implementations, the computing device(s) 110 can utilize data indicative of employer preferences for certain skills for certain types of jobs. In some implementations, the computing device(s) 110 can utilize data indicating the frequency with which certain skills are included in job posting of similar jobs (e.g., showing industry preference for the skill). Such data can be obtained by a third party and/or via web crawling techniques (e.g., of job postings, of articles, or the like).

Additionally, or alternatively, at (212), the computing device(s) 110 can determine one or more suggested job skill(s) for inclusion in the job posting 112. The suggested job skills are different from the one or more identified skills in the job posting 112. For example, the computing device(s) 110 can compare the identified skills to data indicative of employer and/or industry preferences (as described herein) to determine whether certain preferred and/or important skills are not included in the job posting 112.

As (214), the computing device(s) 110 can provide an output 218 indicative of the one or more skill(s) associated with the job posting 112. For example, the output 218 can be provided for display on a user interface via a display device 108. The one or more skill(s) can be presented (e.g., on the user interface) in order of the level of importance 216 for each of the respective skills. Additionally, or alternatively, the output 218 can be indicative of the one or more suggested job skill(s). The output 218 can be provided to a computing device 220 of a third party that is associated with the job posting 112 (e.g., employer). In this way, the system and methods of the present disclosure can allow a third party to leverage the computational resources of the computing system 104 to identify and recommend additional skills to be included in the job posting 112 (e.g., based on employer, industry preferences). This can lead to an increase in qualified and/or preferred candidates.

FIG. 9 depicts an example computing device 400 with components according to example embodiments of the present disclosure. The computing device 400 can be included with and/or representative of the computing device(s) described herein (e.g., 102, 110). The computing device 400 can include one or more processor(s) 402 and one or more memory device(s) 404. The one or more processor(s) 402 can be any suitable processing device (e.g., a processor core, a microprocessor, an ASIC, a FPGA, a controller, a microcontroller, etc.) and can be one processor or a plurality of processors that are operatively connected. The memory device(s) 404 can include one or more non-transitory computer-readable storage medium(s), such as RAM, ROM, EEPROM, EPROM, flash memory devices, magnetic disks, etc., and combinations thereof.

The memory device(s) 404 can store information accessible by the one or more processor(s) 402, including computer-readable instructions 406 that can be executed by the one or more processor(s) 402. The instructions 406 can be any set of instructions that can be executed by the one or more processor(s) 402 to cause the one or more processor(s) 402 to perform operations, such as any of the operations and functions of the computing device(s) 110 and/or for which the computing device(s) 114 are configured, as described herein, the operations for extracting job skills (e.g., one or more portion(s) of methods 200, 300), etc. The one or more memory device(s) 404 can also store data 408 that can be retrieved, manipulated, created, or stored by the one or more processor(s) 402. The data 408 can be stored in one or more database(s) (e.g., locally, located in multiple locales). The data 408 can include any of the data and/or information described herein such as, for example, data indicative of job postings, models, vocabulary, skills associated with a job, etc.

The computing device 400 can also include a communication interface 410 used to communicate with one or more other devices over one or more network(s). The communication interface 410 can include any suitable components for interfacing with one or more network(s), including for example, transmitters, receivers, ports, controllers, antennas, or other suitable components.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer processes discussed herein can be implemented using a single computing device or multiple computing devices (e.g., servers) working in combination. Databases and applications can be implemented on a single system or distributed across multiple systems. Distributed components can operate sequentially or in parallel.

Furthermore, computing tasks discussed herein as being performed at the computing system (e.g., a server system) can instead be performed at a user computing device. Likewise, computing tasks discussed herein as being performed at the user computing device can instead be performed at the computing system.

While the extraction process according to the present disclosure has been described in the context of a job posting, this is not intended to be limiting. For instance, the extraction processes described herein can be applied to any content (e.g., unstructured content) to extract certain information from that content. For example, the processes can be applied to resumes, descriptions of projects, public talks, question and answer content (e.g., websites), blogs, etc. However, the extraction process is particularly applicable to a skills section of a job posting which can present difficulty for traditional extractors.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of extracting job skills from a job posting, comprising:
obtaining, by one or more computing devices, data indicative of a job posting, wherein the job posting comprises textual content associated with a job;
identifying, by the one or more computing devices using a machine-learned model, a portion of the textual content that is descriptive of one or more skills associated with the job, wherein the portion of the textual content is in a first format;
converting, by the one or more computing devices, the portion of the textual content that is descriptive of the one or more skills associated with the job from the first format to a second format, wherein the second format comprises one or more text strings, wherein each of the one or more text strings is formatted as separate from the other one or more text strings;
determining, by the one or more computing devices, the one or more skills associated with the job based at least in part on one or more of the text strings; and
providing, by the one or more computing devices, an output indicative of the one or more skills associated with the job posting.

2. The computer-implemented method of claim 1, wherein identifying, by the one or more computing devices, the portion of the textual content that is descriptive of one or more skills associated with the job comprises:
inputting, by the one or more computing devices, data indicative of the textual content associated with the job into the machine-learned model; and
obtaining, by the one or more computing devices, a model output that is indicative of the portion of the textual content that is descriptive of one or more skills associated with the job.

3. The computer-implemented method of claim 1, wherein the second format comprises a list of the one or more text strings.

4. The computer-implemented method of claim 1, wherein determining, by the one or more computing devices, the one or more skills associated with the job based at least in part on one or more of the text strings comprises:
processing, by the one or more computing devices, one or more of the text strings to identify the one or more skills based at least in part on one or more expression patterns.

5. The computer-implemented method of claim 1, wherein determining, by the one or more computing devices, the one or more skills associated with the job based at least in part on one or more of the text strings comprises:
accessing, by the one or more computing devices, data indicative of a vocabulary that comprises a plurality of terms related to a plurality of job skills; and
comparing, by the one or more computing devices, one or more of the text strings to the vocabulary; and
determining, by the one or more computing devices, the one or more skills based at least in part on the comparison of one or more of the text strings to the vocabulary.

6. The computer-implemented method of claim 1, wherein determining, by the one or more computing devices, the one or more skills associated with the job based at least in part on one or more of the text strings comprises:
parsing, by the one or more computing devices, one or more of the text strings to identify a potential skill;
determining, by the one or more computing devices, a confidence score associated with the potential skill, wherein the confidence score is indicative of the likelihood that the potential skill is at least one of the skills associated with the job; and
identifying, by the one or more computing devices, the potential skill as at least one of the skills associated with the job when the confidence score exceeds a threshold.

7. A computing system for extracting job skills from a job posting, comprising:
one or more processors; and
one or more memory devices, the one or more memory devices storing instructions that when executed by the one or more processors cause the one or more processors to perform operations, the operations comprising:
obtaining data indicative of a job posting, wherein the job posting comprises textual content associated with a job;
identifying a portion of the textual content that is descriptive of one or more skills associated with the job using a machine-learned model;
converting the portion of the textual content that is descriptive of the one or more skills associated with the job from a first format to a second format, wherein the second format comprises one or more text strings, wherein each of the one or more text strings is formatted as separate from the other one or more text strings;
determining the one or more skills associated with the job based at least in part on the one or more text strings of the portion of the textual content that is descriptive of the one or more skills associated with the job; and
providing an output indicative of the one or more skills associated with the job posting.

8. The computing system of claim 7, wherein the operations further include:
determining an importance level for each of the one or more skills associated with the job posting, the importance level indicating the importance of the respective job skill to the job, and
wherein the output is provided for display on a user interface via a display device, and wherein the one or more skills are presented in order of the level of importance for each of the respective skills.

9. The computing system of claim 7, wherein the operations further include:
determining one or more suggested job skills for inclusion in the job posting, wherein the suggested job skills are different from the one or more determined skills associated with the job.

10. The computing system of claim 9, wherein the output is indicative of the one or more suggested job skills, and wherein the output is provided to a third party that is associated with the job posting.

11. One or more tangible, non-transitory computer-readable media storing computer-readable instructions that when executed by one or more processors cause the one or more processors to perform operations, the operations comprising:
obtaining data indicative of a job posting, wherein the job posting comprises textual content associated with a job;
identifying a portion of the textual content that is descriptive of one or more skills associated with the job using a machine-learned model;
converting the portion of the textual content that is descriptive of one or more skills associated with the job from a first format to a second format, wherein the second format comprises one or more strings, wherein each of the one or more strings is formatted as separate from the other one or more strings;
determining the one or more skills associated with the job based at least in part on one or more of the strings; and
providing an output indicative of the one or more skills associated with the job posting.

12. The one or more tangible, non-transitory computer-readable media of claim 11, wherein the second format comprises a list of the one or more strings, and wherein each string is formatted as a separate bullet point.

13. The computer-implemented method of claim 1, wherein each text string is representative of a separate computing unit for processing.

14. The computer-implemented method of claim 1, wherein the machine-learned model is trained based at least in part on training data indicative of labeled job postings.
